(19) United States
(12) Patent Application Publication
(10) Pub. No.: US 2011/0182141 A1
(43) Pub. Date: Jul. 28, 2011

(54) METHOD AND SYSTEM FOR MONITORING A LOGGING TOOL POSITION IN A BOREHOLE

(75) Inventors: Timur Vyacheslavovich Zhamikov, Moscow (RU); Masafumi Kukuhara, Moscow (RU); Igor Vitalievich Borodin, Katy, TX (US); Dimitri Vladilenovich Pissarenko, Moscow (RU)

(73) Assignee: Schlumberger Technology Corporation, Cambridge, MA (US)

(21) Appl. No.: 13/058,887

(22) PCT Filed: Aug. 14, 2008
(86) PCT No.: PCT/RU2008/000519

§ 371 Date: Mar. 31, 2011

(51) Int. Cl. G01V 1/40; E21B 47/09

(52) U.S. Cl. 367/25

(57) ABSTRACT

The invention relates to the area of borehole acoustics, in particular, to monitoring a logging tool position in a borehole, namely detection and estimation of a borehole logging tool eccentricity based on the measurement and analysis of mixed surface waves waveforms. The method is characterized by the steps of registering acoustic signals generated by passage of acoustic waves in the borehole while logging and detecting the misalignment of the logging tool to the axis of the borehole by the presence of mixed surface waves. A system for monitoring a logging tool position in a borehole comprising means for registering acoustic signals generated by passage of acoustic waves while logging and data processing means for detecting mixed surface waves propagating along the borehole wall.

### FIELD OF THE INVENTION

The invention relates to the area of borehole acoustics, in particular, to monitoring a logging tool position in a borehole, namely detection and estimation of a borehole logging tool eccentricity based on the measurement and analysis of mixed surface waves waveforms. The term eccentricity is used to describe how off-center a tool (its shape is usually cylindrical) is within casing or openhole. The tool is concentric when its axis coincides with borehole (casing) axis. When they do not coincide, the tool is eccentric. In simple cases of eccentricity it is usually assumed that tool axis is parallel to borehole axis. But more general case is possible, when the tool is not only shifted from borehole axis, but is inclined as well.

### BACKGROUND ART

Conventional borehole acoustic logging tools are designed to be operated at the center of a borehole. This centered tool assumption is traditionally used during data analysis and processing. Violation of this condition introduces bias into results of measurements and their interpretation. Therefore, ability to measure tool eccentricity and correct the bias, or eliminate and understand the bias effects is significantly important.

There are several methods of identification and characterization of tool eccentricity. One of the options is to analyze caliper measurements (designed for borehole diameter estimation), for example, U.S. Pat. No. 5,469,736. Advantage of this measurement is that it is direct. Drawback is that the sensors (e.g. caliper arms, hydrophones, and antenna) are mounted on a different tool. As a result, measured eccentricity may lead to erroneous conclusions because the measurement is done at different point. This is especially important for acoustic tools because their flexibility makes possibility of wrong results even higher. Besides, caliper measurement is sensitive to presence of mudcake, formation type, etc. It means that the result may not be applicable to eccentricity correction required for processing of data obtained by the tool.

To summarize, usually tool position either is very difficult to characterize (or there are large errors) or, at best, only indirect inferences can be made (procedures are not systematic/algorithmic and depend on the skill of the interpreter). Thus, there is a need for independent measurement of tool eccentricity.

In this invention we describe method and apparatus which provide consistent approach to detection and estimation of tool eccentricity. It is based on mixed surface waves (MSWs) concept and exploits their unique propagation behavior and sensitivity to eccentricity.

MSWs (which include whispering gallery waves, creeping waves, etc.) can appear in case of wave propagation along interface which has non zero effective curvature. The latter means geometrical curvature, velocity gradient or any combination of those. First treatments of MSWs in academic literature date back to 60s. They have been studied and described mathematically [J. B. Keller, A geometrical theory of diffraction. In Calculus of Variations and Its Applications. pp. 27-52, Ed.: L. M. Graves, New-York, (1958); V. M. Babich, Propagation of Rayleigh waves on the surface of homogeneous elastic body of an arbitrary form, Dokl. Akad. Nauk. SSSR, v. 137, p. 1263 (1961); I. A. Molotkov, P. V. Krauklis, Mixed surface waves on the boundary of the elastic medium and fluid, Izvestia Acad. Sc. USSR, Phys. Solid Earth, v. 9 (1970); V. M. Babich, N, Ya. Kirpichnikova, The boundary-layer method in diffraction problems, v. 3, Springer, Berlin, Heidelberg, (1979); B. J. Botter, J. van Arkel, Circumferential propagation of acoustic boundary waves in boreholes, J. Acoustic. Soc. Am., v. 71, p. 790 (1982); A. F. Siggins, A. N. Stokes, Circumferential propagation on elastic waves on boreholes and cylindrical cavities, Geophysics, v. 52, p. 514 (1987)]. MSWs were observed in laboratory experiment [V. G. Gratsinskiy, Investigation of elastic waves in model of borehole. Izv. AN USSR, geophys. series, v. 6, p. 322 (1964); V. G. Gratsinskiy, Amplitudes of creeping waves on wellbore surface. Izv. AN USSR, geophys. series, v. 6, p. 819 (1964); P. G. Gilbershtein, G. V. Gubanova, Quasicreep of compressional waves in case of concave refracting boundary, Izv. AN USSR, physics of earth, p. 48 (1973)]. However, MSWs have not been used in borehole acoustics applications so far.

### SUMMARY OF THE INVENTION

An aim of the invention is to provide an efficient method for monitoring a logging tool position in the borehole.

Accordingly a first aspect of the invention provides a method for monitoring a logging tool position in a borehole, the method comprises registering acoustic signals generated by passage of acoustic waves in the borehole while logging and detecting the misalignment of the logging tool to the axis of the borehole by the presence of mixed surface waves.

In preferred embodiment the method further comprises determining one or more wave characteristics of mixed surface waves propagating along the borehole wall based on the registered acoustic signals and estimating a borehole tool eccentricity based on the determined wave characteristics of mixed surface waves.

In preferred embodiments, the step of determining wave characteristics of mixed surface waves propagating along the borehole wall based on the registered acoustic signals includes the steps of extracting the mixed surface waves from other components of detected acoustic signals, and inverting the results for estimating a borehole tool eccentricity.

In one preferred embodiment, the method further comprises the step of exciting acoustic waves in the borehole so as to generate mixed surface waves propagating along the borehole wall prior to registering acoustic signals generated by passage of said acoustic waves.

In further embodiment of this aspect of the invention said acoustic waves are excited by at least one acoustic source displaced from the borehole axis.

In further embodiment of this aspect of the invention acoustic signals are registered by azimuthally distributed detectors array.

In other embodiment of this aspect of the invention acoustic signals are registered by the matrix of the detectors.

In other embodiment of this aspect of the invention the wave characteristics of mixed surface waves are at least one of the arrival times, amplitudes and degree of the excitation of mixed surface waves. Another aim of the invention is to provide a system for monitoring a logging tool position in a borehole. The system comprises means for registering acoustic signals generated by passage of acoustic waves while logging, data processing means for detecting mixed surface waves propagating along the borehole wall and for determining one or more wave characteristics of said mixed surface waves.

In preferred embodiments of the invention the system further includes means for calculating the borehole tool eccentricity based on the determined wave characteristics of mixed surface waves.

In one preferred embodiment, acoustic waves are induced by natural reasons.

In further preferred embodiment, the system further comprises means for exciting acoustic waves placed in the borehole or on the logging tool so as to generate mixed surface waves propagating along the borehole wall.

In further embodiment of the invention said means for exciting acoustic waves comprises at least one acoustic source displaced from the borehole axis.

In further preferred embodiments, said means for registering acoustic waves comprises azimuthally distributed detectors array.

In other embodiment of this aspect of the invention said means for registering acoustic waves comprises matrix of detectors.

Other aspects and advantages of the invention will be apparent from the following description and the appended claims.

### BRIEF DESCRIPTION OF THE DRAWINGS

FIG. 1 shows an example illustrating introduction of new sources to the logging tool (in addition to existing standard source (centered)) with special placement.

FIG. 2 shows an example of the system with matrix arrangement of detectors.

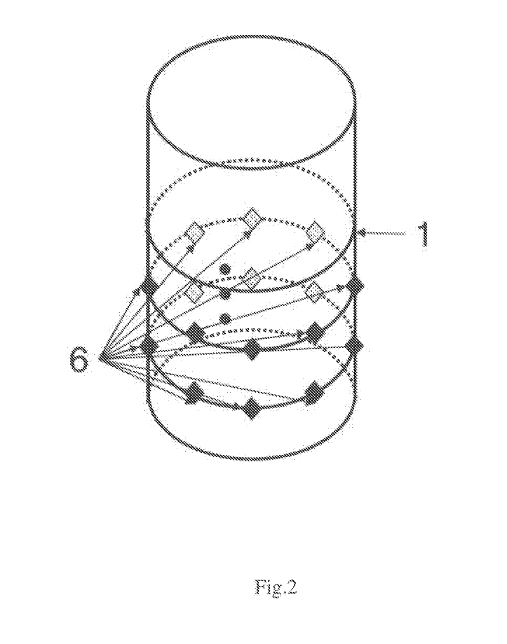

FIG. 3 shows an example of placement of detectors on borehole wall according to spiral-like grid formed by one of possible families of MSWs;

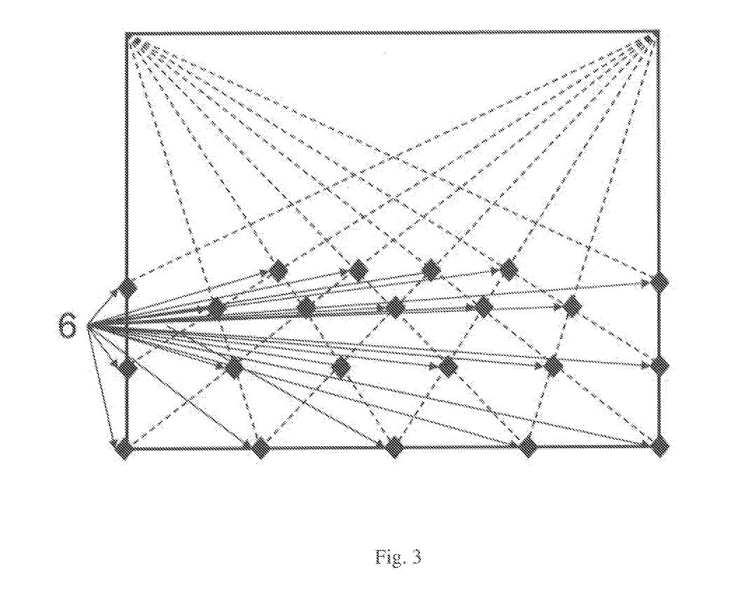

FIG. 4 shows an example of natural excitation of MSWs when tool hits borehole wall;

FIG. 5 shows an example illustrating MSWs excitation with standard source of eccentered tool;

FIG. 6 shows an example illustrating how tool eccentricity can create complex detectors configuration in borehole geometry;

FIG. 7 shows an example (side view) illustrating how tool bending can create complex detectors' configuration.

### DESCRIPTION OF THE PREFERRED EMBODIMENTS OF THE INVENTION

According to the invention acoustic signals generated by passage of acoustic waves while logging are registered and the misalignment of the logging tool 1 to the axis 3 of the borehole having a wall 2 is detected by the presence of mixed surface waves.

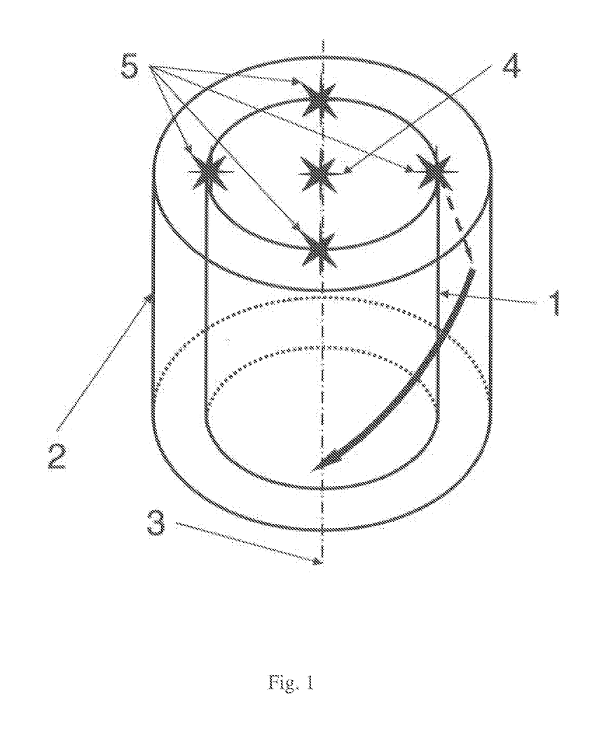

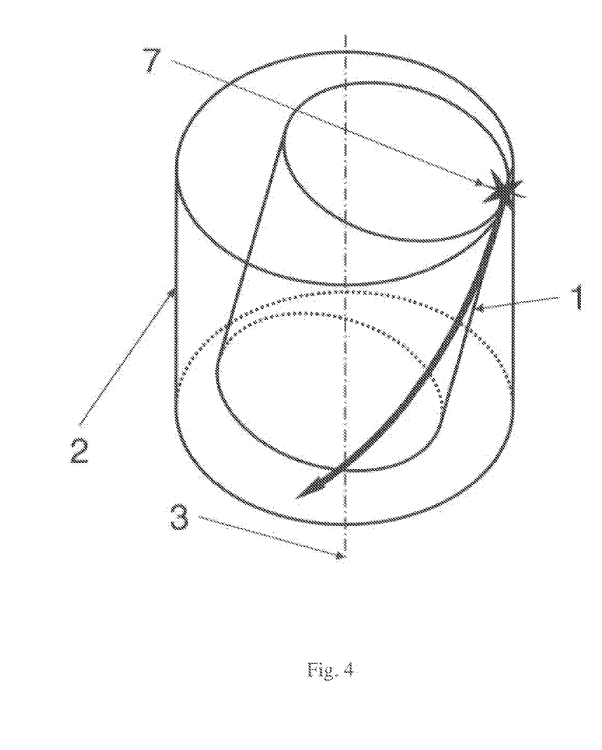

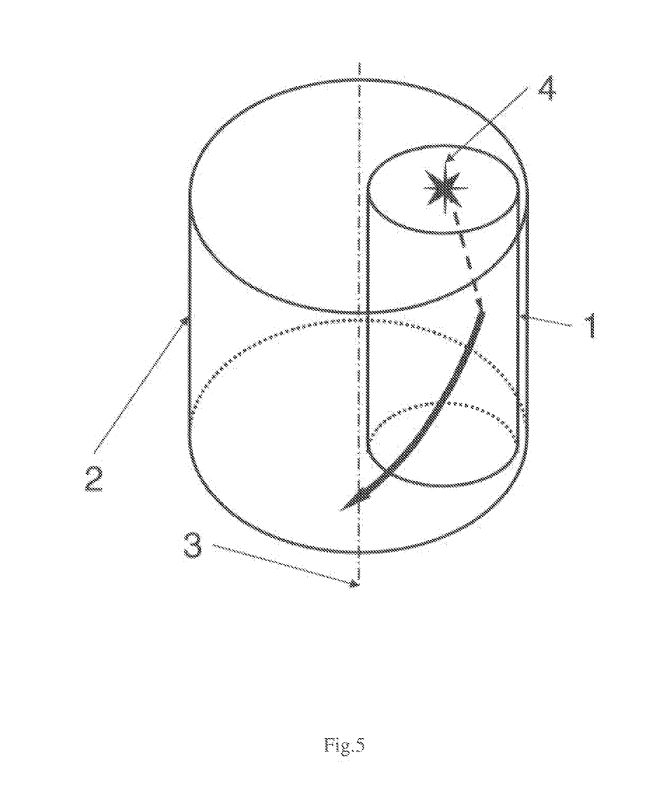

Acoustic waves can be induced either by natural reasons or intentionally. Examples of the causes of acoustic excitation are: road noise during logging, standard source, intentionally introduced source, specially placed one, etc (FIG. 1). Such generation step is optional because in many implementations acoustic field will be created naturally. For instance, acoustic signal is created when the tool 1 touches the wall 2 (one of examples of road noise). In this case source 7 of excitation is on borehole wall 2 and MSWs will be generated naturally (FIG. 4). Another example is eccentered acoustic tool 1. Typically, in this case its standard source 4 is eccentered as well, that naturally leads to excitation of MSWs (FIG. 5). These are examples when there is no need to change the tool (natural or already existing source(s) are used). On the other hand, one may want to introduce new source(s) 5 and/or to place them in a special way for eccentricity measurement. For instance, they can be added when the tool does not have one. Possible reasons for special placement of the source(s) are the desire to improve/optimize the measurement, to enhance the quality and accuracy of results, to guarantee that at least one MSW will be excited, etc. For instance, it can be done by generating MSWs on purpose with pre-eccentered source(s) 5 (FIG. 1). Additional source(s) 5 with large eccentricity can be used because usually in this case MSWs are easier to generate and detect. Thus, eccentricity estimation will be easier. Another example is addition of reference source. One of reasons can be intention to compare data from several sources. In all implementations source eccentricity can be the only reason for generation of MSWs (e.g. ideal borehole, no velocity gradient, etc.) or one of several (e.g. together with altered zone with velocity gradient in direction normal to borehole wall 2 is present, etc.). What is important is that MSWs characteristics are sensitive to it. Even when no MSWs are generated, some conclusions about eccentricity can be made.

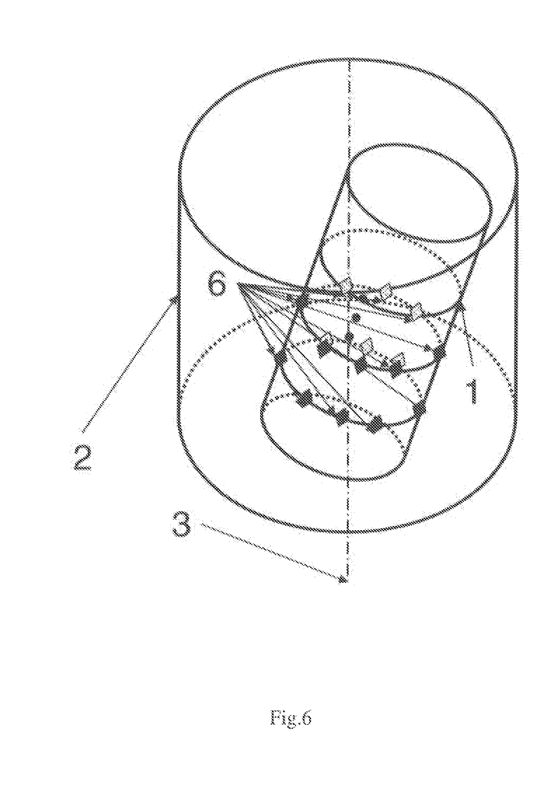

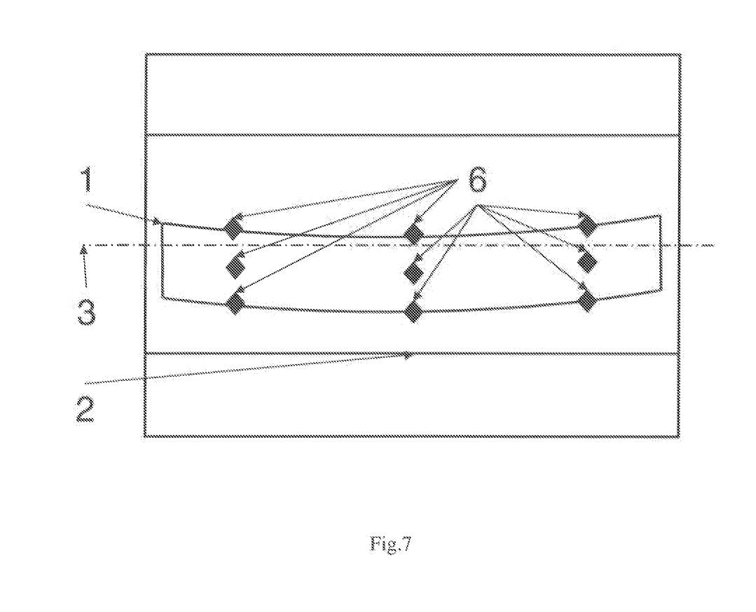

Acoustic signals can be registered by a single detector 6, by set of detectors 6 with array/matrix/purpose fit configurations, etc. Complicated detectors configuration can appear due to various circumstances. For instance, it can happen due to tool 1 eccentricity (FIG. 6). Another example is a tool 1 bent under its own weight in borehole that leads to rather complex geometry of detectors 6 matrix (FIG. 7). Tool or tool string bending can be due to other numerous causes as well. One more possibility for complex geometry is tool or tool string buckling. One of the most commonplace situations when it happens is when compression strength is applied along tool- or drillstring. Particular attention to various deformations should be paid for acoustic tools because of their natural flexibility (desirable for acoustic measurement).

Source(s)/detector(s) configuration can be chosen in such a way that measured MSWs data would have optimal sensitivity to tool eccentricity. For example, it can be done using theoretical/model based MSW propagation analysis, etc. Another possible reason to tailor configurations of source(s)/detector(s) is to enhance the quality and accuracy of results, for instance, to be able to compare with reference source data during inversion step. These comments are valid for both generation and detection steps.

Then, in case of MSW presence one or more wave characteristics of said MSW propagating along the borehole wall 2 are determined on the basis of the registered acoustic signals and borehole tool 1 eccentricity is estimated based on the determined wave characteristics of mixed surface waves. The step of determining wave characteristics of mixed surface waves propagating along the borehole wall 2 based on the registered acoustic signals can include the step of extracting the mixed surface waves from other components of detected acoustic signals and inverting the results for said characteristics. Tool eccentricity/positioning is estimated by inverting MSW characteristics for properties of tool 1 eccentricity/positioning in borehole.

Several examples of possible implementations of inversion step are: MSWs travel times tomography, full waveform inversion, velocity tomography, etc. Since in some cases eccentricity information obtained at this step can be helpful for extraction/separation step as well it can be worthwhile to iteratively repeat these steps several times. Inversion implementations are based on the sensitivity of MSWs characteristics to source eccentricity.

The simplest case of inversion step is ideal situation with centered source. In this case no MSWs will be excited, detected, extracted. It means that inability to generate MSWs is a good indication of centered tool.

Another example of inversion procedure is for the situation of ideal borehole conditions (perfectly round borehole, constant diameter, no altered zone (velocity gradients), etc.). In this case MSWs on borehole wall will be excited in borehole only when acoustic source is eccentered. Their characteristics (degree of their excitation, amplitude, etc.) are sensitive to source eccentricity (e.g. the excitation will depend on it). Thus, by measuring MSWs in detected acoustic signal and inverting (e.g., utilizing dependencies of MSWs characteristics on source eccentricity) these data with proper account for MSWs physics one will be able to characterize source position in borehole (and/or required correction). Since placement of the source on the tool is known one can infer tool position. For instance, using detected arrival times one can estimate (first approximation) initial model (formation velocities, etc.). Alternatively, MSWs amplitudes and degree of their excitation (or other characteristics of MSWs) may be used for this purpose. These calculations should be done taking into account equations for dependence of MSWs velocities on formation and mud speeds, curvature radius, frequency and other factors when calculating MSWs paths and characteristics. Having initial model guess one can calculate arrival times for centered source model. Deviations of measured data from this case can be used as an input to iterative inversion procedure with proper account for MSWs physics (e.g., MSWs dispersion depending on various parameters like curvature radius, etc.). For instance, one can vary source(s)/detector(s) positions to get the best fit to real data by steepest decent methods. As a criterion one can employ best least squares fit (for example). Another possibility is to use sensitivity of MSWs excitation (differences in their arrival times) to source eccentricity. It is usually the stronger the larger eccentricity. It also means that larger eccentricities could be easier to detect because, usually, it facilitates MSWs excitation and makes their detection more robust and accurate.

In more complex cases (e.g. in presence of radial alteration) MSWs can appear (can be excited) even when the source is centered and many factors (velocity gradient, variations of borehole diameter, washouts geometry, etc.) will affect their propagation. However, even in this case MSWs propagation and their characteristics stay sensitive to source eccentricity. To extract this information one can resort to model based inversion approach and/or use full theory of MSWs (taking into account effective curvature of the interface, etc.) for inversion.

When eccentricity information is available correction step can be added, if necessary, to correct for eccentricity effects. Examples of its implementations are: perturbative correction, measurement model based correction, correlation based correction, etc. For instance, if eccentricity and its effects are not large one can linearize theory of measurement of interest near point of zero eccentricity and derive dependence of measurement results on eccentricity under this assumption. In more difficult cases one can use measurement model to calculate required eccentricity correction numerically. Another example is the case, when some correlations (empirical, numerical, etc.) between eccentricity and measurement results are known. They can also be utilized to calculate eccentricity correction.

According to the invention, one needs to register MSWs with a system, then extract/separate them in the acoustic signal from its other components and invert the results for properties of tool eccentricity/positioning in the borehole. The acoustic waves including MSWs can be intentionally excited prior to registration. Essential components of such a system are means for exciting acoustic waves—an acoustic source (or array of sources) 4, 5, which is placed in such a way as to excite MSWs, or natural excitation, a detector (or detectors array) 6 (placement can be variable—not necessarily at borehole wall) and data processing means (not shown). There are many options regarding the type of the source(s). The most common one is a monopole source but other sources, for example, dipole, quadrupole, direct excitation at the borehole wall (e.g. hammer source), array of sources, etc. can be also used. Natural excitation of acoustic waves excitation, like road noise during logging can be also used. Placement of the source(s) 4, 5 is selected on the basis of knowledge of physics of MSWs propagation. The source will produce an acoustic signal. By using an acoustic detector (or detectors array) 6 it is possible to detect MSWs together with other components of acoustic signal(s).

To monitor a logging tool 1 position in a borehole first it is necessary to extract/separate MSWs from other components of acoustic signal in detector (or detector array) data. As example, to extract/separate MSWs one could use the following procedure. Knowing expected trajectories of MSWs one can collect and arrange waveforms from detectors lying along the MSW path (that, generally speaking, will be curved line on borehole wall). To evaluate MSWs slownesses and travel times one can perform semblance analysis (see, for example, C. V. Kimball, T. L. Marzetta, Semblance processing of borehole acoustic array data, Geophysics, v. 49, p. 274, 1984) on these waveforms taking properly into account MSWs physics (e.g., MSWs dispersion depending on various parameters like curvature radius, etc.). The latter is significantly different from common notions (e.g., slownesses are not the same as formation slownesses as is the case for head waves; dispersion laws are quite different from those for borehole modes, etc.). This procedure can then be repeated iteratively with inversion step to refine positions of source(s)/detector(s).

When MSWs have been extracted/separated, to estimate tool eccentricity/positioning it is necessary to invert MSWs characteristics for properties of tool 1 eccentricity/positioning in borehole. Several examples of possible implementations of inversion step are: MSWs travel times tomography, full waveform inversion, velocity tomography, etc. Since in some cases eccentricity information obtained at this step can be helpful for extraction/separation step as well it can be worthwhile to iteratively repeat these steps several times. Inversion implementations are based on the sensitivity of MSWs characteristics to source eccentricity.

To correct for eccentricity effects (if necessary), one should perform correction step. For example one can use the following procedures: perturbative correction, measurement model based correction, correlation based correction, etc. For instance, if eccentricity and its effects are not large one can linearize theory of measurement of interest near point of zero eccentricity and derive dependence of measurement results on eccentricity under this assumption. In more difficult cases one can use measurement model to calculate required eccentricity correction numerically. Another example is the case, when some correlations (empirical, numerical, etc.) between eccentricity and measurement results are known. They can also be utilized to calculate eccentricity correction.

General structure of the invention presented above can be exemplified by describing one of the possible embodiments. According to the concept, invention embodiment consists of the system and the method. The target is to monitor a logging tool 1 position in a borehole and two essential components are acoustic source(s) placed in such a way as to excite MSWs (or source of natural excitation of acoustic signal), and detector array. The system can be made of just an acoustic source displaced with respect to borehole axis and azimuthally distributed detectors array. Examples of possible acoustic sources are numerous. It can be monopole piezoelectric type of transmitter, dipole source, hammer source (which directly excites MSWs at borehole wall) etc. For detectors one can use, for example, 3C geophones or accelerometers touching borehole wall.

Working of the apparatus can be schematically represented as follows. First, an acoustic source (or natural source) emits acoustic signal. Because of source eccentricity, this will eventually give rise to propagation of surface waves along borehole wall (for example, see FIG. 1, 3, 4, 5). Due to the natural curvature of the borehole wall these paths will also have geometrical curvature. Thus, MSWs will be generated. They will start propagating along the borehole wall. Then acoustic wavefield can be detected with detector(s) 6. MSWs and other components of the wavefield will be registered.

The data processing means (not shown) for determining one or more wave characteristics of said mixed surface waves propagating along the borehole wall based on the registered acoustic signals and inverting said characteristics for properties of tool 1 eccentricity/positioning in borehole. can represent any data processing means enabling to perform the steps coded as computer-executable instructions. For example, the data processing means can be a personal computer, a server or the like.

Regarding the method, in this embodiment example its goal is to find tool eccentricity/positioning in borehole. According to the invention to do so one should extract/separate MSWs in detected acoustic signal and invert this data from detector(s) to tool position. One of the simplest implementations of the separation step is to use procedure described above. That is, to arrange waveforms recorded by detectors lying on the approximate path of the same MSW and apply semblance analysis (see, for example, C. V. Kimball, T. L. Marzetta, Semblance processing of borehole acoustic array data, Geophysics, v. 49, p. 274, 1984) taking into account MSWs physics. This means correcting for dependence of MSW trajectory, velocity, dispersion etc. on various parameters like on curvature radius of the MSW path, signal frequency etc. [I. A. Molotkov, P. V. Krauklis, Mixed surface waves on the boundary of the elastic medium and fluid, Izvestia Acad. Sc. USSR, Phys. Solid Earth, v. 9 (1970); P. Krauklis, N. Kirpichnikova, A. Krauklis, D. Pissarenko, T. Zharnikov, “Mixed Surface Waves—Nature, Modelling and Features”, abstracts of 69^{th} EAGE conference EAGE2007] when calculating semblance.

For inversion step the following procedure can be used. Using detected arrival times one can estimate first approximation to initial model (formation velocities, etc.). These calculations should be done taking into account equations for dependence of MSWs velocities on formation and mud speeds, curvature radius, frequency and other factors when calculating MSWs paths and characteristics [I. A. Molotkov, P. V. Krauklis, Mixed surface waves on the boundary of the elastic medium and fluid, Izvestia Acad. Sc. USSR, Phys. Solid Earth, v. 9 (1970); P. Krauklis, N. Kirpichnikova, A. Krauklis, D. Pissarenko, T. Zharnikov, “Mixed Surface Waves—Nature, Modelling and Features”, abstracts of 69^{th} EAGE conference EAGE2007]. The model can be anisotropic, e.g., if curvature radius is not constant, there is velocity gradient (that may vary in space), intrinsic formation anisotropy, etc. In general case interface curvature at the same point will depend on the direction of MSW propagation. In this sense there is additional type of anisotropy present, which should be properly taken into account. Having initial model guess one can calculate arrival times for centered source model. Deviations of measured data from this case can be used as an input to iterative inversion procedure with proper account for MSWs physics (e.g., MSWs dispersion depending on various parameters like curvature radius, etc.). As one of the possibilities, one can vary source(s)/detector(s) positions to get the best fit to real data by steepest decent methods. As a criterion one can employ best least squares fit. As a result of this inversion procedure one will be able to characterize source position in borehole. Since placement of the source on the tool is known one can infer tool position. If correction for eccentricity effects is required as well, correction step should be included in invention embodiment. For instance, one can linearize theory of measurement of interest near point of zero eccentricity and derive dependence of measurement results on eccentricity under this assumption. Using this dependence and knowing eccentricity from previous steps necessary correction can be derived.

While the invention has been described with respect to a limited number of embodiments, those skilled in the art will devise other embodiments of this invention which do not depart from the scope of the invention as disclosed therein. Accordingly the scope of the invention should be limited only by the attached claims.

1. A method for monitoring a logging tool position in a borehole characterized by the steps of registering acoustic signals generated by passage of acoustic waves in the borehole while logging and detecting the misalignment of the logging tool to the axis of the borehole by the presence of mixed surface waves.

2. A method of claim 1, further comprising determining one or more wave characteristics of mixed surface waves propagating along the borehole wall based on the registered acoustic signals and estimating a borehole tool eccentricity based on the determined wave characteristics of mixed surface waves.

3. A method of claim 2, wherein the step of determining wave characteristics of mixed surface waves propagating along the borehole wall based on the registered acoustic signals includes the steps of extracting the mixed surface waves from other components of detected acoustic signals and inversing the results for estimating a borehole tool eccentricity.

4. A method of claim 2, wherein the wave characteristics of mixed surface waves are at least one of the arrival times, amplitudes and degree of the excitation of mixed surface waves.

5. A method of claim 1, wherein acoustic waves are induced by natural reasons.

6. A method of claim 1, further comprising the step of exciting acoustic waves in the borehole so as to generate mixed surface waves propagating along the borehole wall prior to registering acoustic signals generated by passage of said acoustic waves.

7. A method of claim 6, wherein said acoustic waves are excited by at least one acoustic source displaced from the borehole axis.

8. A method of claim 1, wherein acoustic signals are registered by azimuthally distributed detectors array.

9. A method of claim 1, wherein acoustic signals are registered by the matrix of the detectors.

10. A system for monitoring a logging tool position in a borehole comprising means for registering acoustic signals generated by passage of acoustic waves while logging and data processing means for detecting mixed surface waves propagating along the borehole wall.

11. A system of claim 10, further comprising means for determining one or more wave characteristics of said mixed surface waves and calculating the borehole tool eccentricity based on the determined wave characteristics of mixed surface waves.

12. A system of claim 10, further comprising means for exciting acoustic waves placed in the borehole or on the logging tool so as to generate mixed surface waves propagating along the borehole wall.

13. A system of claim 12, wherein said means for exciting acoustic waves comprises at least one acoustic source displaced from the borehole axis.

14. A system of claim 10, wherein said means for registering acoustic waves comprises azimuthally distributed detectors array.

15. A system of claim 10, wherein said means for registering acoustic waves comprises matrix of detectors.
